(19) United States
(12) Patent Application Publication
(10) Pub. No.: US 2014/0119389 A1
(43) Pub. Date: May 1, 2014

(54) INTERFACE FOR ASYNCHRONOUS VIRTUAL CONTAINER CHANNELS AND HIGH DATA RATE PORT

(71) Applicant: LSI CORPORATION, Milpitas, CA (US)

(72) Inventors: Chenggang Duan, Shanghai (CN); Yifan Lin, Shanghai (CN); Tao Wang, Shanghai (CN); Lin Sun, Shanghai (CN)

(73) Assignee: LSI Corporation, Milpitas, CA (US)

(21) Appl. No.: 13/672,348

(22) Filed: Nov. 8, 2012

(30) Foreign Application Priority Data
Oct. 26, 2012 (CN) 201210417377.8

(51) Int. Cl. H04L 7/00

(52) U.S. Cl. CPC H04L 7/00
USPC 370/503

(57) ABSTRACT

Data rate justification circuitry adapted to control one or more communications between a physical layer device and a link layer device. In a first direction of communication, the data rate justification circuitry is configured to receive first virtual container data from the physical layer device over two or more asynchronous virtual container channels, and to synchronize the first virtual container data and aggregate the first virtual container data for transmission to the link layer device over a high data rate port. In a second direction of communication, the data rate justification circuitry is configured to receive second virtual container data from the link layer device over the high data rate port, and to decode data rate information associated with the second virtual container data and separate the second virtual container data for transmission to the physical layer device over the two or more asynchronous virtual container channels.

### PRIORITY CLAIM

The present application claims priority to the Chinese patent application identified as 201210417377.8, filed on Oct. 26, 2012, and entitled “Interface for Asynchronous Virtual Container Channels and High Data Rate Port,” the disclosure of which is incorporated by reference herein in its entirety.

### FIELD

The field relates generally to network-based communication systems, and more particularly to techniques for providing an interface between multiple asynchronous virtual container channels and a single high data rate port in a circuit emulation over packet environment in such communication systems.

### BACKGROUND

Conventional network-based communication systems include systems configured to operate in accordance with well-known synchronous transport standards, such as the synchronous optical network (SONET) and synchronous digital hierarchy (SDH) standards.

The SONET standard was developed by the Exchange Carriers Standards Association (ECSA) for the American National Standards Institute (ANSI), and is described in the document ANSI T1.105-1988, entitled “American National Standard for Telecommunications—Digital Hierarchy Optical Interface Rates and Formats Specification” (September 1988), which is incorporated by reference herein. SDH is a corresponding standard developed by the International Telecommunication Union (ITU), set forth in ITU standards documents G.707 and G.708, which are incorporated by reference herein.

The basic unit of transmission in the SONET standard is referred to as synchronous transport signal level-1 (STS1). It has a data rate of 51.84 Megabits per second (Mbps). The corresponding unit in the SDH standard is referred to as synchronous transport module level-0 (STM0). Synchronous transport signals at higher levels comprise multiple STS1 or STM0 signals. For example, an intermediate unit of transmission in the SONET standard is referred to as synchronous transport signal level-3 (STS3). It has a data rate of 155.52 Mbps. The corresponding unit in the SDH standard is referred to as STM1.

A given STS3 or STM1 signal is organized in frames having a duration of 125 microseconds (μsec), each of which may be viewed as comprising nine rows by 270 columns of bytes, for a total frame capacity of 2,430 bytes per frame. The first nine bytes of each row comprise transport overhead (TOH), while the remaining 261 bytes of each row are referred to as a synchronous payload envelope (SPE). Synchronous transport via SONET or SDH generally involves a hierarchical arrangement in which an end-to-end path may comprise multiple lines with each line comprising multiple sections. The TOH includes section overhead (SOH), pointer information, and line overhead (LOH). The SPE includes path overhead (POH). Additional details regarding signal and frame formats can be found in the above-cited standards documents.

In conventional SONET or SDH network-based communication systems, synchronous transport signals like STS3 or STM1 are mapped to or from corresponding higher-rate optical signals such as a SONET OC-12 signal or an SDH STM4 signal. An OC-12 optical signal carries four STS3 signals, and thus has a data rate of 622.08 Mbps. The SDH counterpart to the OC-12 signal is the STM4 signal, which carries four STM1 signals, and thus also has a data rate of 622.08 Mbps. The mapping of these and other synchronous transport signals to or from higher-rate optical signals generally occurs in a physical layer device commonly referred to as a mapper, which may be used to implement an add-drop multiplexer (ADM) or other node of a SONET or SDH communication system.

Such a mapper typically interacts with a link layer processor. A link layer processor is one example of what is more generally referred to herein as a link layer device, where the term “link layer” generally denotes a switching function layer. Another example of a link layer device is a field programmable gate array (FPGA). These and other link layer devices can be used to implement processing associated with various packet-based protocols, such as Internet Protocol (IP) and Asynchronous Transfer Mode (ATM), as well as other protocols, such as Fiber Distributed Data Interface (FDDI). A given mapper or link layer device is often implemented in the form of an integrated circuit.

In many communication system applications, it is necessary to carry circuit-switched traffic such as T1/E1 traffic over a packet network such as an IP network or an ATM network. For example, it is known that T1/E1 traffic from a SONET/SDH network or other circuit-switched network may be carried using virtual containers (VCs). The SONET/SDH mapper maps/de-maps the SONET/SDH transport signals (frames) to/from VCs. When it is desired or necessary to carry VCs over an IP network or other packet network, the VCs are packed into packets of the IP network or other packet network. In the opposite transmission direction, VCs from the packets of the IP network or other packet network are unpacked for transmission in the SONET/SDH network. The link layer processor packs/unpacks VCs into/from the packets.

The packing/unpacking of VCs or other time-division multiplexed (TDM) data to/from IP packets or other types of packets may be performed in accordance with a circuit emulation protocol, such as the CEP protocol described in IETF RFC 4842, “Synchronous Optical Network/Synchronous Digital Hierarchy (SONET/SDH) Circuit Emulation over Packet (CEP),” April 2007, which is incorporated by reference herein.

### SUMMARY

While data rates of transmission channels carrying virtual container data (virtual container channels) associated with a physical layer device, such as a SONET/SDH mapper, are typically asynchronous, a link layer device, such as a link layer processor, typically does not have the ability to input/output multiple asynchronous virtual container channels. Embodiments of the invention provide an interface between multiple asynchronous virtual container channels of a physical layer device and a single high data rate port of a link layer device.

In one embodiment, an apparatus comprises data rate justification circuitry adapted to control one or more communications between a physical layer device and a link layer device. In a first direction of communication, the data rate justification circuitry is configured to receive first virtual container data from the physical layer device over two or more asynchronous virtual container channels, and to synchronize the first virtual container data and aggregate the first virtual container data for transmission to the link layer device over a high data rate port. In a second direction of communication, the data rate justification circuitry is configured to receive second virtual container data from the link layer device over the high data rate port, and to decode data rate information associated with the second virtual container data and separate the second virtual container data for transmission to the physical layer device over the two or more asynchronous virtual container channels.

Other embodiments may implement other types of data rate justification and virtual container data aggregation/separation techniques to support interface functionality between a physical layer device and a link layer device.

### BRIEF DESCRIPTION OF THE DRAWINGS

FIG. 1 is a block diagram of a network-based communication system comprising at least one node having data rate justification circuitry according to one embodiment.

FIG. 2 shows a CEP header format as employed in the FIG. 1 system.

FIG. 3 shows a justification super frame format implemented by the data rate justification circuitry in the FIG. 1 system.

FIG. 4 shows a data rate scenario when no justification is implemented by the data rate justification circuitry in the FIG. 1 system.

FIG. 5 shows a data rate scenario when positive justification is implemented by the data rate justification circuitry in the FIG. 1 system.

FIG. 6 shows a data rate scenario when negative justification is implemented by the data rate justification circuitry in the FIG. 1 system.

FIG. 7 shows an aggregate frame format implemented by the data rate justification circuitry in the FIG. 1 system.

FIG. 8 shows an ingress module of the data rate justification circuitry in the FIG. 1 system.

FIG. 9 shows a virtual container adaptor of the FIG. 8 ingress module.

FIG. 10 shows an egress module of the data rate justification circuitry in the FIG. 1 system.

FIG. 11 shows a virtual container generator of the FIG. 10 egress module.

FIG. 12 shows an integrated circuit having data rate justification circuitry according to one embodiment.

### DETAILED DESCRIPTION

Embodiments of the invention will be illustrated herein in conjunction with an exemplary network-based communication system which includes a physical layer device, a link layer device and other elements configured in a particular manner. It should be understood, however, that the disclosed techniques are more generally applicable to any communication system application in which it is desirable to provide data rate justification functionality to support circuit emulation over packet protocols. Thus, while reference will be made below to SONET/SDH networks and IP networks, it is to be understood that the disclosed techniques may be used in other circuit-switched networks and other packet networks.

As mentioned above, at the boundary of a SONET/SDH network and a packet network, SONET/SDH frames are de-mapped into VCs, and then these VCs are packed into packets and transmitted on the packet network. In the opposite transmission direction, VCs are unpacked from the packet network and then mapped into SONET/SDH frames to be transmitted on the SONET/SDH network.

It is realized, however, that synchronous transport signals (STS-n/STM-n) can be de-mapped into multiple VC channels, and that the data rates of these VC channels are asynchronous. For example, the STM1 signal is the most used SDH signal. One STM1 signal can be de-mapped into one VC4 channel, three VC3 channels, 63 VC12 channels, or 84 VC11 channels. Although most conventional link layer processors are software programmable and have the flexibility to upgrade to support the VC data format, such link layer processors do not have sufficient hardware interfaces to receive/transmit multiple VC channels separately.

Accordingly, embodiments of the invention provide methods and apparatus that address these and other issues by providing an interface between multiple asynchronous VC channels of a mapper and a single high data rate port of a link layer processor. It is to be understood that by the phrase “asynchronous VC channels,” it is meant that a given VC channel can be asynchronous with one or more other given VC channels and/or can be asynchronous with the single high data rate port. For example, one embodiment of the invention includes an interface that adds extra frame headers on VC frames to denote data rate justification, and then aggregates multiple asynchronous VC channels on a single high data rate port. Most conventional link layer processors have such a single high data rate port, e.g., C4 container port. As such, an improved CEP solution is provided for a conventional link layer processor architecture.

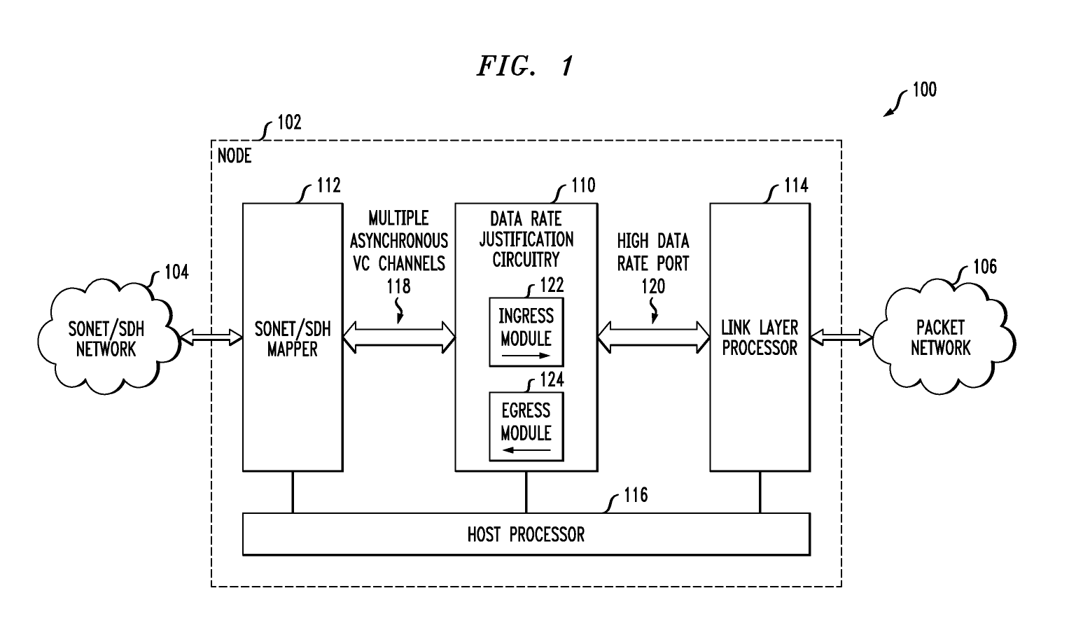

FIG. 1 shows a network-based communication system 100 in an illustrative embodiment. The system 100 includes a node 102 arranged to support communication between a SONET/SDH network 104 and a packet network 106. The packet network 106 may comprise, for example, an IP network, an ATM network or other type of network utilizing packet switching functionality. The networks 104 and 106 may comprise routers, switches or other network elements of respective SONET/SDH and packet networks operating in accordance with known standards. It should be noted that the term “SONET/SDH” as used herein refers to SONET and/or SDH. Embodiments to be described herein with reference to SDH synchronous transport signal terminology such as STM0 and STM1 should be understood to encompass analogous SONET embodiments using corresponding synchronous transport signal terminology such as STS1 and STS3.

Although shown in the figure as being separate from the networks 104 and 106, the node 102 may be viewed as being part of one of the networks 104 or 106. For example, the node 102 may comprise an edge node of network 104 or network 106. Alternatively, the node may represent a standalone router, switch, network element or other communication device arranged between nodes of the networks 104 and 106.

The node 102 of system 100 comprises data rate justification circuitry 110 coupled between a mapper 112 and a link layer processor 114. Data rate justification circuitry 110 functions as an interface, as will be explained further herein, between mapper 112 and link layer processor 114. The node 102 also includes a host processor 116 that is used to configure and control one or more of data rate justification circuitry 110, mapper 112 and link layer processor 114. Portions of the host processor functionality may be incorporated into one or more of elements 110, 112 or 114 in other embodiments. Also, although the data rate justification circuitry 110 is shown in FIG. 1 as being separate from the mapper 112 and link layer processor 114, in other embodiments, the data rate justification circuitry 110 may be implemented at least in part within at least one of the mapper 112 and the link layer processor 114. Accordingly, whether separate therefrom or incorporated therein, it is to be appreciated that data rate justification circuitry is used to control one or more communications between mapper 112 and link layer processor 114.

The data rate justification circuitry 110, mapper 112, link layer processor 114, and host processor 116 in this embodiment may be installed on a line card or other circuit structure of the node 102. Each of the elements 110, 112, 114 and 116 may be implemented as a separate integrated circuit, or one or more of the elements may be combined into a single integrated circuit. Various elements of the system 100 may therefore be implemented, by way of example and without limitation, utilizing a microprocessor, an FPGA, an application-specific integrated circuit (ASIC), a system-on-chip (SOC) or other type of data processing device, as well as portions or combinations of these and other devices. One or more other nodes of the system 100 in one or both of networks 104 and 106 may each be implemented in a manner similar to that shown for node 102 in FIG. 1.

The data rate justification circuitry 110 controls certain communications between the mapper 112 and the link layer processor 114, in order to enable the mapper 112 to input/output VCs over multiple independent (asynchronous) VC channels 118 and the link layer processor 114 to input/output the corresponding VCs over a single high data rate port 120. The mapper 112 and link layer processor 114 are examples of what are more generally referred to herein as physical layer devices and link layer devices, respectively. The term “physical layer device” as used herein is intended to be construed broadly so as to encompass any device which provides an interface between a link layer device and a physical transmission medium of a network-based system. The term “link layer device” is also intended to be construed broadly, and should be understood to encompass any type of processor which performs processing operations associated with a link layer of a network-based system.

The mapper 112 and link layer processor 114 may include functionality of a conventional type. Such functionality, being well known to those skilled in the art, will not be described in detail herein, but may include functionality associated with known mappers, such as the LSI Hypermapper™, Ultramapper™ and Supermapper™ devices, and known link layer devices, such as the LSI Link Layer Processor. These LSI devices are commercially available from LSI Corporation of Milpitas, Calif., U.S.A. However, in accordance with embodiments of the invention, it is also to be understood that mapper 112 and link layer processor 114 are adapted to implement one or more techniques described herein.

The node 102 may also include other processing devices not explicitly shown in the figure. For example, the node may comprise a conventional network processor such as an LSI Advanced PayloadPlus® network processor in the APP300, APP500 or APP650 product family, also commercially available from LSI Corporation.

Although only single instances of the data rate justification circuitry 110, mapper 112 and link layer processor 114 are shown in the FIG. 1 embodiment, other embodiments may comprise instances of these and other system elements. For example, a group of multiple mappers may be arranged in a master-slave configuration that includes at least one master mapper and a plurality of slave mappers. Other embodiments may include only a single slave mapper, rather than multiple slave mappers. Numerous other configurations of system elements are possible, as will be appreciated by those skilled in the art.

The data rate justification circuitry 110 is coupled between the mapper 112 and the link layer processor 114 and includes an ingress module 122 and an egress module 124. The ingress module 122 supports a direction of communication through node 102 from the SONET/SDH network 104 to the packet network 106 (also referred to as a drop path). The egress module 124 supports a direction of communication through node 102 from the packet network 106 to the SONET/SDH network 104 (also referred to as an insert path). The data rate justification circuitry 110 operates in conjunction with the mapper 112 to add extra frame headers on VC frames to denote data rate justification, and to aggregate multiple asynchronous VC channels 118 on a single high data rate port 120 associated with link layer processor 114. The ability to aggregate multiple asynchronous VC channels on a single high data rate port improves operation of the CEP protocol or other circuit emulation over packet protocols used to pack/unpack VCs to/from packets.

More particularly, in the ingress direction, ingress module 122 receives data from mapper 112 over multiple independent VC channels 118, and synchronizes these asynchronous channels to a data rate of the high data rate port 120. Ingress module 122 also reserves space and fills certain fields in a CEP packet header, and adds a justification super frame header, to be explained in detail below, for each CEP packet to denote the data rate justification. Then, data from two or more of the multiple VC channels is packed together and transmitted to link layer processor 114 over the high data rate port 120.

In the egress direction, egress module 124 requests (or otherwise receives) data from the link layer processor 114 through the high data rate port 120. The link layer processor 114 is adapted to add the extra justification super frame header on each CEP packet to denote the data rate justification for each VC channel. Then, egress module 124 decodes both the extra justification super framer header and CEP packet header received over the high data rate port 120 from link layer processor 114, adapts the data rate justification, and sends VCs on corresponding ones of the multiple VC channels 118 to SDH/SONET mapper 112 with proper data rate and format.

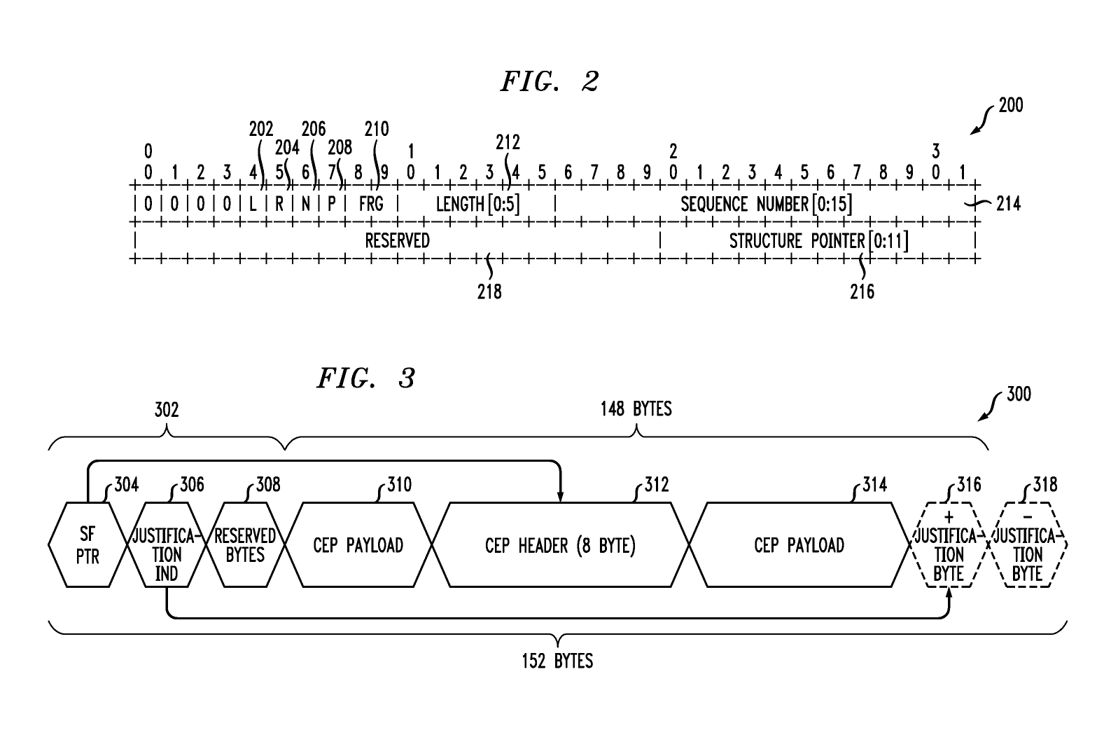

The operation of the data rate justification circuitry 110 will now be described in greater detail with reference to FIGS. 2 through 12.

As described in the above-referenced IETF RFC 4842, a packet that is generated in accordance with the CEP protocol has a CEP frame format that includes a CEP header and a CEP payload. The CEP payload includes the SONET/SDH VC data to be transmitted over packet network 106. Thus, data rate justification circuitry 110 interfaces the SONET/SDH mapper 112 which operates in a VC frame format with link layer processor 114 which operates in a CEP frame format. The format of a CEP header is shown in FIG. 2.

In CEP header format 200 of FIG. 2, the L bit 202 indicates whether a failure condition has been detected in SONET/SDH network 104, while the R bit 204 indicates whether a loss of packet synchronization has occurred in packet network 106. The N (negative) and P (positive) bits (206 and 208, respectively) are used to relay pointer adjustment events across packet network 106. The FRG bit field 210 is used to denote the fragmentation status of the SONET/SDH data. The Length field 212 (Length [0:5]) indicates the length of the CEP header plus the CEP payload (plus the length of a Real-Time Transport Protocol (RTP) header, if used). The Sequence Number field 214 (Sequence Number [0:15]) designates a sequence number assigned to a given packet. The Structure Pointer field 216 (Structure Pointer [0:11]) designates the offset of the first byte of the SONET/SDH VC frame within the CEP payload. The CEP header frame also includes a Reserved field 218. It is to be understood that, in other embodiments, different header formats may be used.

In particular, data rate justification circuitry 110 utilizes the Structure Pointer field 216 of the CEP header 200 of FIG. 2. That is, in the ingress direction, ingress module 122 inserts data in field 216, as will be further explained below, and leaves other fields empty for link layer processor 114 to process. In the egress direction, egress module 124 decodes field 216 to determine the start position of the VC frame.

We now describe how data rate justification circuitry 110 functions as an interface between the multiple asynchronous VC channels 118 and the single high data rate port 120, enabling link layer processor 114 to receive VC frames from multiple asynchronous VC channels on a single high data rate port. Embodiments utilize a frame formatting technique that generates a justification super frame (JSF). As will be understood from the description below, both data rate justification circuitry 110 and link layer processor 114 are able to generate JSFs. FIG. 3 illustrates JSF format 300.

As is known, for a single VC channel, VC data is packed into a VC super frame. In a VC12 application, the frame is 500 μS. In accordance with the CEP protocol, the VC super frame is then packed into a CEP packet as CEP payload, and an 8-byte CEP header is added to the CEP payload to form a CEP packet. The CEP header has a format as described above in the context of FIG. 2. Embodiments of the invention then provide for packing the CEP packet, itself packed with a VC super frame, as a data payload in JSF 300.

FIG. 3 assumes a VC12 application. As shown, a CEP packet for JSF 300 has a size of 148 bytes. JSF 300 includes a JSF header 302 which is added onto the CEP packet to denote data rate justification and the start position of the CEP packet it conveys. In this example, the CEP packet of JSF 300 includes CEP payload 310, CEP header 312, and CEP payload 314. That is, the CEP data in JSF 300 actually contains data from two CEP packets. It is assumed here that CEP payload 310 is the tail of a first CEP packet, and CEP header 312 and CEP payload 314 constitute the data associated with a second CEP packet. Thus, it is to be understood that transmission of a CEP header and corresponding CEP payload may not necessarily be completed in one JSF, but rather may span sequential JSFs. Nonetheless, in this example, JSF header 302 in FIG. 3 points to the start position of the CEP packet including CEP header 312 and CEP payload 314.

The first byte field of JSF header 302, labeled SF PTR 304, is a super frame pointer. SF PTR 304 points to the position of the first byte of the 8-byte-CEP header 312 in JSF 300. If there are multiple CEP headers in the same JSF, SF PTR 304 points to the CEP header closest thereto. The pointer value of SF PTR 304 varies from 1 to 148; a value of 0 denotes that there is no CEP header in the current JSF.

The second byte field of JSF header 302, labeled Justification Ind. 306, includes two bits to indicate the type of data rate justification that is to be implemented. The data rate of the subject data is justified by using one or both of positive justification byte field 316 and negative justification byte field 318. In one embodiment, the two bits of Justification Ind. 306 are designated as follows:

00: Positive justification byte field 316 is used, negative justification byte field 318 is not used;

01: Neither positive justification byte field 316 nor negative justification byte field 318 are used; and

10: Both positive justification byte field 316 and negative justification byte field 318 are used.

Accordingly, the last two bytes fields 316 and 318 of JSF 300 implement the data rate justification. The usage of these bytes is dictated by Justification Ind. 306. When a justification byte is indicated as being needed, a byte from the subject CEP packet is inserted in one or both of the justification byte fields 316 and 318. When a justification byte is not needed, the justification byte fields are reserved, and no useful data is placed in the fields. The device that receives the JSF is configured to discard any data in those fields if Justification Ind. 306 indicates that data rate justification is not needed.

It is to be understood that the step of adding bytes to the JSF to thereby justify the data rate of the subject data is used in order to synchronize the VC data that comes from the same and/or separate asynchronous (independent) VC channels 118 with the data rate of the high data rate port 120. Examples of scenarios involving no data rate justification, positive data rate justification, and negative data rate justification are given below.

Note that extra Reserved Bytes 308 are appended at the end of JSF header 302, and the use of these reserved bytes is left to the discretion of the user. For the example application, JSF header 302 includes one reserved byte, thus giving JSF 300 a total length of 152 bytes.

It is to be appreciated that the data rate of each VC channel (each of the multiple VC channels 118 in FIG. 1) associated with mapper 112 is recovered from the SONET/SDH network 104, while the data rate of the high data rate port 120 associated with link layer processor 114 is provided by a global positioning system (GPS) clock. The GPS clock is referred to as a “nominal clock” and thus the data rate associated with the high data rate port 120 is referred to as the “nominal data rate.”

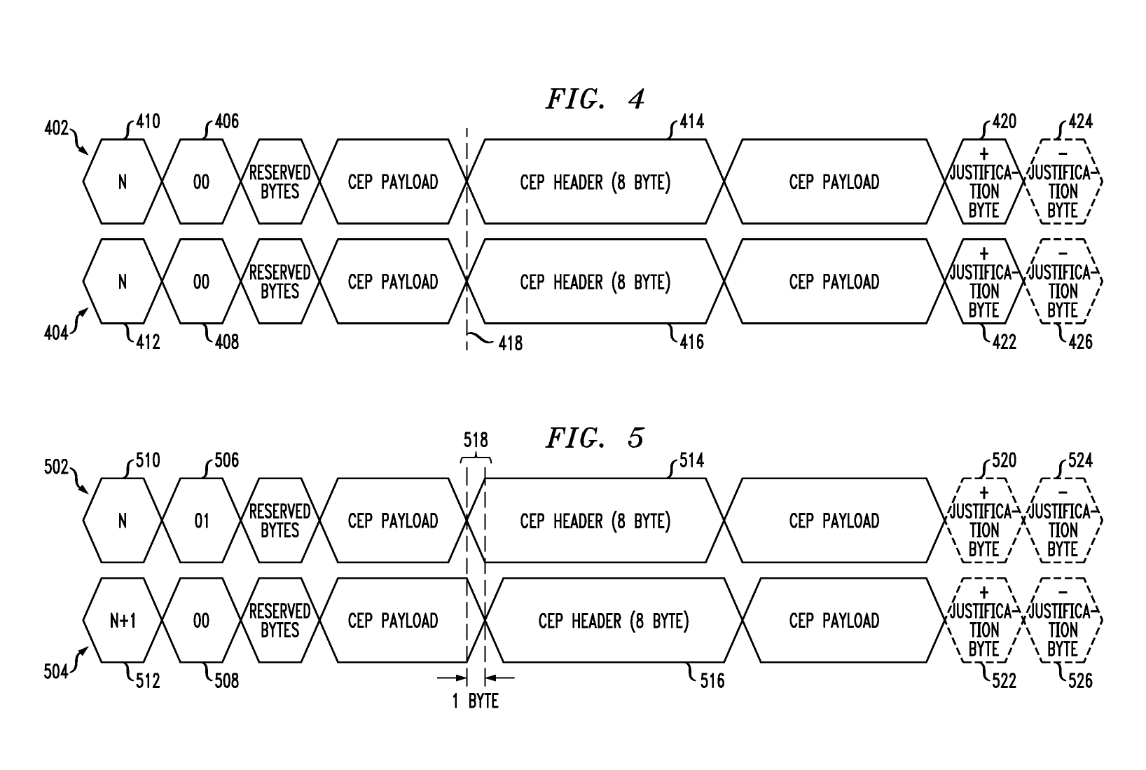

If the data rate of a subject VC channel (one of channels 118 in FIG. 1) is equal to the nominal data rate of the high data rate port (120 in FIG. 1), then no data rate justification is needed for this particular channel. This is illustrated by successive JSFs 402 and 404 in FIG. 4. Note that the Justification Ind. byte field 406 in JSF 402 and 408 in JSF 404 are both 00. As such, in the exemplary justification indicator designation given above, a positive justification byte is used to carry payload while a negative justification byte is not. That means that a byte of CEP data is added to each one of the positive justification byte fields 420 and 422, but no CEP data is added to either one of negative justification byte fields 424 or 426. Note that the SF PTR pointers (410 in JSF 402 and 412 in JSF 404) remain the same between two successive 500 μs frames. Note also that the position of the CEP headers (414 in JSF 402 and 416 in JSF 404) in successive 500 μs frames is aligned, as denoted by dashed line 418.

If the data rate of a subject VC channel (one of channels 118 in FIG. 1) is slower than the nominal data rate of the high data rate port (120 in FIG. 1), positive data rate justification is needed for this channel. This is illustrated by successive JSFs 502 and 504 in FIG. 5. Note that the Justification Ind. byte field 506 in JSF 502 is 01 and 508 in JSF 504 is 00. As such, in the exemplary justification indicator designation given above, neither a positive justification byte nor a negative justification byte is used to carry payload when the Justification Ind. byte field is 01, i.e., no CEP data is added to the positive or negative justification byte fields, 520 and 524, in JSF 502. However, since Justification Ind. byte field 508 is 00, CEP data is added to positive justification byte field 522, but not to negative justification byte field 526, in JSF 504. Note that the SF PTR pointer of the frame after the positive justification frame is thus incremented by 1. That is, while SF PTR pointer 510 in JSF 502 is designated as N, SF PTR 512 in JSF 504 is designated as N+1. Note also that the position of the CEP headers (514 in JSF 502 and 516 in JSF 504) in successive 500 μs frames is offset, with the CEP header 516 in JSF 504 being 1 byte behind the CEP header 514 of JSF 502, as denoted by dashed lines 518.

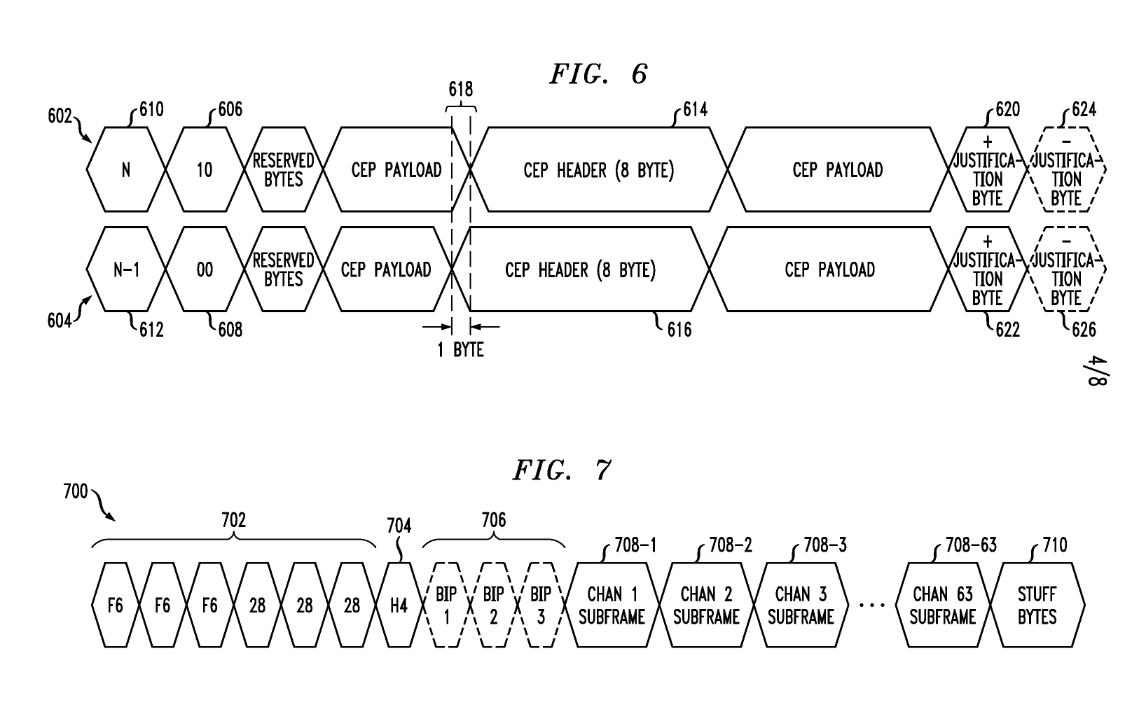

If the data rate of a subject VC channel (one of channels 118 in FIG. 1) is faster than the nominal data rate of the high data rate port (120 in FIG. 1), negative data rate justification is needed for this channel. This is illustrated by successive JSFs 602 and 604 in FIG. 6. Note that the Justification Ind. byte field 606 in JSF 602 is 10 and 608 in JSF 604 is 00. As such, in the exemplary justification indicator designation given above, both a positive justification byte and a negative justification byte are used to carry payload when the Justification Ind. byte is 10, i.e., CEP data is added to each of the positive and negative justification byte fields, 620 and 624, in JSF 602. However, since Justification Ind. byte field 608 is 00, CEP data is added to positive justification byte field 622, but not to negative justification byte field 626, in JSF 604. Note that the SF PTR pointer of the frame after the positive justification frame is thus decremented by 1. That is, while SF PTR pointer 610 in JSF 602 is designated as N, SF PTR 612 in JSF 604 is designated as N−1. Note also that the position of the CEP headers (614 in JSF 602 and 616 in JSF 604) in successive 500 μs frames is offset, with the CEP header 616 in JSF 604 being 1 byte ahead of the CEP header 614 of JSF 602, as denoted by dashed lines 618.

In order to save buffer size consumed by the frame formatting technique described herein, the 500 μs JSF is further divided into four even subframes, each of which are transmitted in 125 μs. In the example VC12 application, the size of a sub frame is 38 bytes.

Then, subframes from all VC channels that contributed VC data are packed together to form an aggregate frame. The aggregate frame is transmitted on the high data rate port 120 in 125 μs . Therefore, a JSF for each VC channel is transmitted in four successive aggregate frames.

In alternate embodiments, a JSF may be divided into a number of subframes other than four (e.g., more generally, D) such that a JSF for each VC channel is transmitted in D successive aggregate frames.

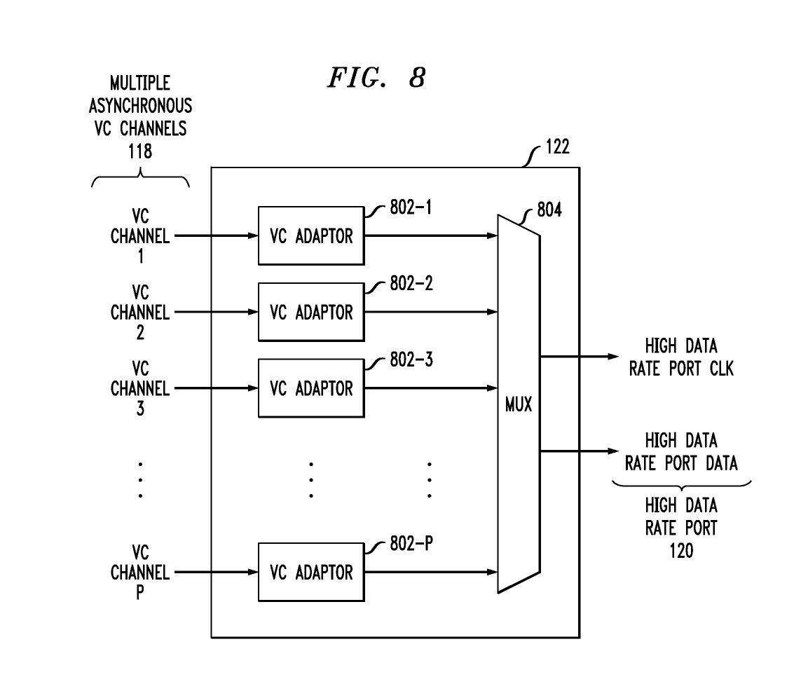

An embodiment of an aggregate frame format is shown as FIG. 7. In the example VC12 application, it is assumed there are a total of 63 subframes packed into aggregate frame 700. Aggregate frame 700 starts with a frame header training sequence 702, which is 0xF6F6F6282828 in this example, followed by a subframe index byte field 704, labeled H4. Two bits of H4 are used in this example:

00: denotes the first 125 μs aggregate frame in the 500 μs period; the subframes, transmitted on current aggregate frame, contain the JSF headers;

01: denotes the second 125 μs aggregate frame in the 500 μs period;

10: denotes the third 125 μs aggregate frame in the 500 μs period; and

11: denotes the fourth 125 μs aggregate frame in the 500 μs period.

Aggregate frame 700 then includes a set of bit interleaved parity (BIP) bytes 706. Each byte provides a parity check for VC channels belonging to the same STS1/STM0 channel. The number of the BIP bytes is dependent on the STM-n application. In one embodiment, the number is 3× bytes. The number of BIP bytes may, however, vary in other embodiments.

According to the SONET/SDH protocol, one STM0 channel may contain 1 VC3 channel or 21 VC12 channels or 28 VC11 channels. For the example application, aggregate frame 700 includes three BIP bytes, each byte checks for 21 VC12 channels.

Next, the aggregate frame 700 includes 63 subframes 708-1, . . . , 708-63. It is understood that these subframes are from different VC channels of the multiple asynchronous VC channels 118. The subframes 708-1, . . . , 708-63 are transmitted in the order of their channel number.

The end of aggregate frame 700 is filled with stuff bytes 710 to pad the data rate, if necessary, to match the high data rate port 120. For the example application, under a 155.52 Megahertz (MHz) clock, the C4 interface port of a link layer processor can transmit 2430 byte per 125 μs, with the last 26 bytes being filled with stuffed bytes.

FIG. 8 shows an ingress module of data rate justification circuitry 110, e.g., ingress module 122 in the FIG. 1 system.

Recall that in the ingress direction, there are multiple asynchronous VC channels collectively referred to as VC channels 118. In FIG. 8, these VC channels are denoted as VC channels 1, . . . , P. Ingress module 122 includes a corresponding number of VC adaptors 802-1, . . . , 802-P, with an input terminal of a VC adaptor being coupled to a VC channel Output terminals of the VC adaptors are coupled to input terminals of a multiplexer (MUX) 804. MUX 804 combines data from the VC adaptors 802-1, . . . , 802-P into an aggregate frame, e.g., as formatted in FIG. 7. MUX 804 then transmits the aggregate frame, along with a clock signal CLK, on the high data rate port 120.

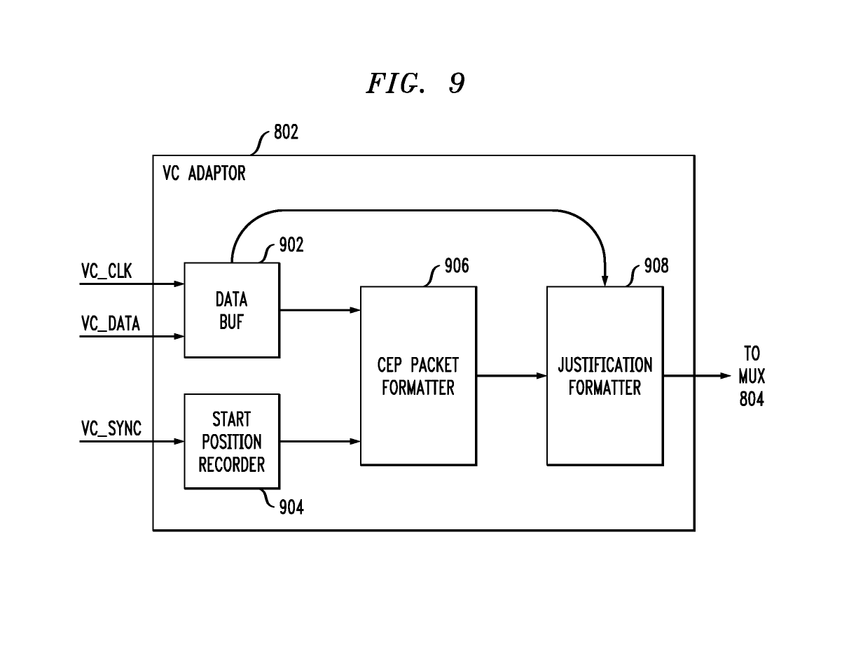

An embodiment of a VC adaptor 802 is illustrated in FIG. 9. As shown, VC adaptor 802 includes a data buffer (DATA BUF) 902, a start position recorder 904, a CEP packet (PKT) formatter 906, and a justification formatter 908.

A VC channel contains three signals VC_CLK, VC_DATA and VC_SYNC. The VC_CLK denotes the VC data rate, VC_Data conveys the VC payload, and VC_SYNC denotes the start of a VC frame.

The VC data is stored into data buffer 902. The VC frame start position is recorded in start position recorder 904. CEP PKT formatter 906 then reads the VC payload data from data buffer 902, adds the CEP header (200 in FIG. 2), and fills the structure pointer field (216 in FIG. 2) in the CEP header with the VC start position (obtained from recorder 904) to form the CEP packet (8-byte CEP header plus CEP payload). Justification formatter 908 adds a justification header on the CEP frame based on the empty/full condition of the data buffer 902 in order to format a JSF (300 in FIG. 3). When data buffer 902 is substantially full, a negative justification is executed. When data buffer 902 is substantially empty, positive justification is executed.

That is, the output of VC adaptor 802 operates at the nominal data rate, as explained above. When DATA BUF 902 is substantially full (i.e., VC data rate is higher than the nominal data rate), the justification formatter 908 performs negative data rate justification, also as explained above. That is, with reference back to JSF 300 in FIG. 3, the formatter 908 sets Justification Ind. bit 306 to 10, uses both justification byte fields 316 and 318 to send CEP packet data, and increases the SF PTR 304 of the next JSF by one. In this way, the VC adaptor 802 is sending out one more byte in a JSF period.

When DATA BUF 902 is substantially empty (i.e., VC data rate is lower than the nominal data rate), the justification formatter 908 performs positive data rate justification, as explained above. That is, the formatter 908 sets Justification Ind. bit 306 to 01, uses neither of the justification byte fields 316 or 318 to send CEP packet data, and decreases SF PTR 304 of the next JSF by one. In this way, the VC adaptor 802 sends out one less byte in a JSF period.

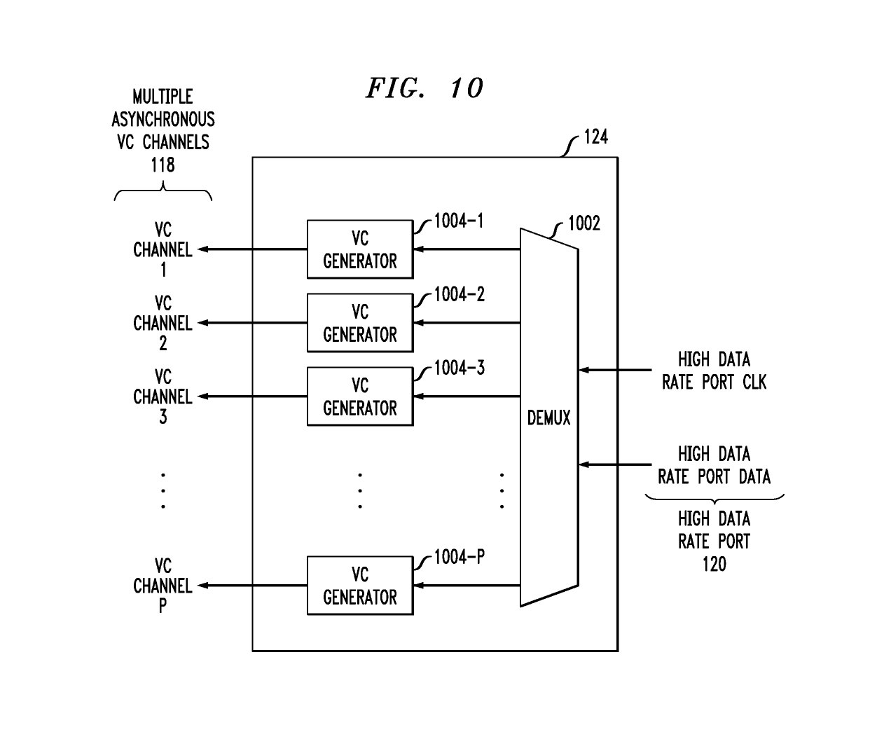

FIG. 10 shows an egress module of data rate justification circuitry 110, e.g., egress module 124 in the FIG. 1 system.

Recall that in the egress direction, the input high data rate streams received over the high data rate port 120 are de-multiplexed into multiple asynchronous VC channels 118. As shown in FIG. 8, this is accomplished by de-multiplexer 1002 and VC generators 1004-1, . . . , 1004-P, which correspond to the multiple VC channels 1, . . . , P. Each VC generator 1004 is configured to recover VC frames.

An embodiment of a VC generator 1004 is illustrated in FIG. 11. As shown, VC generator 1004 includes a justification decoder 1102, a data buffer (DATA BUF) 1004, a VC clock generator (CLK GEN) 1106, and a CEP header formatter 1108.

VC generator 1004 receives the de-multiplexed data stream from the De-MUX 1002. At the VC channel port, the VC generator outputs VC_CLK, VC_DATA and VC_SYNC, which are described above.

The data stream for De-MUX 1002 is stored in data buffer 1104 and input in justification decoder 1102. In justification decoder 1102, the justification header is decoded and removed. By decoding the SF PTR field (304 in FIG. 3) in the justification header, the start position of the CEP packet is detected. Then, the information from the CEP packet is sent to CEP header decoder 1108. By decoding the Justification Ind. field, the data rate justification operation is detected, and this information is sent to VC CLK GEN 1106 to recovery the VC_CLK.

In CEP header decoder 1108, the CEP header is parsed, and the start position of the VC frame is found by decoding the structure pointer field (216 in FIG. 2). Then, this information is used to generate the VC Sync signal which denotes the start position of a VC frame. Meanwhile, the VC payload is transmitted from data buffer 1104. Hence, the entire VC frame is recovered at the output port of the VC generator for transmission on its corresponding VC channel.

In this manner, embodiments provide the ability for a link layer processor to drop/insert multiple asynchronous VC channels through a single high data rate port, which makes it possible to upgrade current link layer processor architectures to operate more efficiently in a CEP application environment.

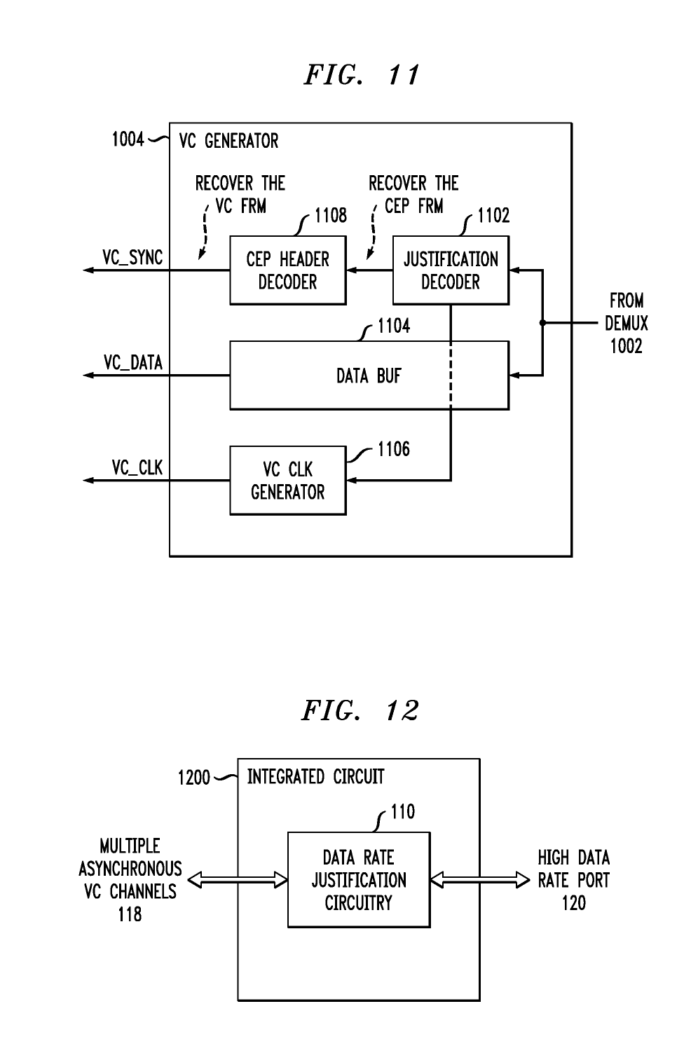

At least a portion of the circuitry and methodologies described herein can be implemented in one or more integrated circuits. In forming integrated circuits, die are typically fabricated in a repeated pattern on a surface of a semiconductor wafer. Each of the die can include a device described herein, and can include other structures or circuits. Individual die are cut or diced from the wafer, then packaged as integrated circuits. One ordinarily skilled in the art would know how to dice wafers and package die to produce integrated circuits. Integrated circuits so manufactured are considered embodiments of this invention. FIG. 12 illustrates an integrated circuit 1200 comprising data rate justification circuitry 110 serving as an interface between multiple asynchronous VC channels 118 and high data rate port 120. In other embodiments, part or all of SONET/SDH mapper 112 and/or link layer processor 114 may be implemented on integrated circuit 1200. In yet further embodiments, portions of data rate justification circuitry 110 may be implemented on one or more integrated circuits other than integrated circuit 1200. One or more of the integrated circuits mentioned herein are suitable for installation on a line card or port card of a router, switch, network element or other communication device.

It is to be appreciated that the particular circuitry arrangements shown in FIGS. 1 and 8-12, and the frame formats of FIGS. 2-7, may be varied in other embodiments. Numerous alternative arrangements of circuitry, signal timing, process flow and frame formats may be used to implement the described data rate justification functionality.

It should be noted that the portions of the data rate justification circuitry 110, and possibly other components of the node 102, may be implemented at least in part in the form of one or more software programs running on a processor. A memory associated with mapper 112, link layer processor 114, or host processor 116 may be used to store executable program code of this type. Such a memory is an example of what is more generally referred to herein as a “computer program product” or a “computer-readable storage medium” having executable computer program code embodied therein. The computer program code when executed in a mapper, link layer processor, host processor, or other communication device processor causes the device to perform one or more operations associated with data rate justification circuitry 110. Other examples of computer program products in embodiments of the invention may include, for example, optical or magnetic disks.

Although embodiments of the invention have been described herein with reference to the accompanying drawings, it is to be understood that embodiments of the invention are not limited to the described embodiments, and that various changes and modifications may be made by one skilled in the art resulting in other embodiments of the invention within the scope of the following claims.

What is claimed is:

1. An apparatus comprising:
data rate justification circuitry adapted to control one or more communications between a physical layer device and a link layer device;
wherein, in a first direction of communication, the data rate justification circuitry is configured to receive first virtual container data from the physical layer device over two or more asynchronous virtual container channels, and to synchronize the first virtual container data and aggregate the first virtual container data for transmission to the link layer device over a high data rate port;
wherein, in a second direction of communication, the data rate justification circuitry is configured to receive second virtual container data from the link layer device over the high data rate port, and to decode data rate information associated with the second virtual container data and separate the second virtual container data for transmission to the physical layer device over the two or more asynchronous virtual container channels.

2. The apparatus of claim 1, wherein the data rate justification circuitry is further configured to format at least a portion of the first virtual container data into a packet format to generate packet formatted data.

3. The apparatus of claim 2, wherein the packet format is a circuit emulation over packet format.

4. The apparatus of claim 2, wherein the data rate justification circuitry is further configured to format at least a portion of the packet formatted data into a data rate justification frame format to generate data rate justification frame formatted data.

5. The apparatus of claim 4, wherein the data rate justification frame format includes an indication of at least one of no data rate justification, a positive data rate justification, and a negative data rate justification with respect to the data rate justification frame formatted data.

6. The apparatus of claim 4, wherein the data rate justification circuitry is further configured to divide the data rate justification frame formatted data into subframes, wherein the subframes are formatted into an aggregate frame format for transmission to the link layer device over the high data rate port.

7. The apparatus of claim 1, wherein the data rate justification circuitry is further configured to decode the second virtual container data by removing an aggregate frame format, a data rate justification frame format, and a packet format, to recover the second virtual container data.

8. The apparatus of claim 1, wherein the physical layer device is a mapper associated with a circuit-switched network.

9. The apparatus of claim 1, wherein the link layer device is a link layer processor associated with a packet network.

10. An integrated circuit comprising the apparatus of claim 1.

11. A communication system comprising:
a plurality of communication devices arranged in one or more networks;
at least one of said communication devices comprising:
a physical layer device;
a link layer device; and
data rate justification circuitry adapted to control one or more communications between the physical layer device and the link layer device;
wherein, in a first direction of communication, the data rate justification circuitry is configured to receive first virtual container data from the physical layer device over two or more asynchronous virtual container channels, and to synchronize the first virtual container data and aggregate the first virtual container data for transmission to the link layer device over a high data rate port;
wherein, in a second direction of communication, the data rate justification circuitry is configured to receive second virtual container data from the link layer device over the high data rate port, and to decode data rate information associated with the second virtual container data and separate the second virtual container data for transmission to the physical layer device over the two or more asynchronous virtual container channels.

12. The system of claim 11, wherein the data rate justification circuitry is further configured to format at least a portion of the first virtual container data into a packet format to generate packet formatted data.

13. The system of claim 12, wherein the packet format is a circuit emulation over packet format.

14. The system of claim 12, wherein the data rate justification circuitry is further configured to format at least a portion of the packet formatted data into a data rate justification frame format to generate data rate justification frame formatted data.

15. The system of claim 14, wherein the data rate justification frame format includes an indication of at least one of no data rate justification, a positive data rate justification, and a negative data rate justification with respect to the data rate justification frame formatted data.

16. The system of claim 14, wherein the data rate justification circuitry is further configured to divide the data rate justification frame formatted data into subframes, wherein the subframes are formatted into an aggregate frame format for transmission to the link layer device over the high data rate port.

17. The system of claim 11, wherein the data rate justification circuitry is further configured to decode the second virtual container data by removing an aggregate frame format, a data rate justification frame format, and a packet format, to recover the second virtual container data.

18. A method comprising:
receiving, in a first direction of communication between a physical layer device and a link layer device, first virtual container data from the physical layer device over two or more asynchronous virtual container channels;
synchronizing the first virtual container data; and
aggregating the first virtual container data for transmission to the link layer device over a high data rate port.

19. The method of claim 18, further comprising:
receiving, in a second direction of communication between the physical layer device and the link layer device, second virtual container data from the link layer device over the high data rate port;
decoding data rate information associated with the second virtual container data; and
separating the second virtual container data for transmission to the physical layer device over the two or more asynchronous virtual container channels.

20. A computer program product having executable computer program code embodied therein, wherein the computer program code when executed in a communication device causes the device to perform the steps of the method of claim 18.
